(19) United States
(12) Patent Application Publication
(10) Pub. No.: US 2008/0086708 A1
(43) Pub. Date: Apr. 10, 2008

(54) System and method for automatic elimination of electromigration and self heat violations of a mask layout block, maintaining the process design rules correctness

(76) Inventor: Dan Rittman, Atlit (IL)

Correspondence Address: DANNY RITTMAN, P.O. Box 2040, Atlit, 30300, omitted

(21) Appl. No.: 11/542,909

(22) Filed: Oct. 5, 2006

(51) Int. Cl. G06F 17/50

(52) U.S. Cl. 716/11

(57) ABSTRACT

A system and method for automatic correction of electromigration (EM) and self heat (SH) violations of a mask layout block, maintaining the process design rules correctness are disclosed. The method includes analyzing polygons for space, width and length, in a mask layout block and obtaining one or more electromigration and/or self heat rules associated with the polygon from a technology and an external constraints file. The system automatically corrects all EM and/or SH violations if found, maintaining the process design rules correctness. The method also includes analysis and automatic correction of contacts and VIA's according to amount and location in order to comply with electromigration and self heat rules as taken from technology or external constraints file. The method provides a violation marker associated with the selected position for the polygon that graphically represents a width, space, length violation. The method and system works on GDSII format files and on industry standards layout editor's database.

### BACKGROUND OF INVENTION

1. Technical Field of the Invention

The present invention is generally related to the field of integrated circuits, and more particularly to a system and method for automatic correction of electromigration and self heating violations within a mask layout block in the metallic, polysilicon, contacts and VIA's interconnects of an integrated circuit device, maintaining the process design rule correctness.

2. Background of the Invention

Nanometer designs contain millions of devices and operate at very high frequencies. The current densities (current per cross-sectional area) in the signal lines and power are consequently high and can result in either signal or power electromigration problems. The electron movement induced by the current in the metal power lines causes metal ions to migrate. That phenomenon of transport of mass in the path of a DC flow, as in the metal power lines in the design, is termed power electromigration. There are two types of electromigration. Uni-Directional, for example power and static signals and Bi-Directional, for example clocks and other switching signals. The most critical is the Uni-Directional electromigration type since the electron ‘erosion’ move constantly in one direction and can cause signal line failure. The power electromigration effect is harmful from the point of view of design reliability, since the transport of mass can cause open circuits, or shorts, to neighboring wires.

Electromigration (EM) is actually not a function of current, but a function of current density. It is also accelerated by elevated temperature. Thus, electromigration is easily observed in Al metal lines that are subjected to high current densities at high temperature over time. The higher current density around the void results in localized heating that further accelerates the growth of the void, which again increases the current density. The cycle continues until the void becomes large enough to cause the metal line to fuse open. Typically the most susceptible to electromigration phenomenon are metallic interconnections of integrated circuit. (IC) EM effects become more prominent as IC feature sizes decrease and as IC frequencies and current densities increase.

EM in IC devices occurs due to direct current flow. High direct current density in an IC device causes atoms and ions in the conductors of the device to move in the opposite direction of the direct current flow. In particular, when high direct current densities pass through thin conductors, metal ions accumulate in some regions and voids form in other regions of the conductors. The accumulation of metal ions may result in a short circuit to adjacent conductors and the voids may result in an open-circuit condition. However, if the current density can be kept below a predetermined EM threshold, EM can be rendered negligible for the life of any particular IC device. Therefore, EM due to direct current flow in IC devices is a major concern with respect to the potential for device failures and the overall reliability of the device.

IC devices may also have alternating current flow. The alternating current density in an IC device that results from alternating current flow causes atoms and ions in the conductors of the device to first move in one direction and then move in the opposite direction, back to their original positions. A plurality of conductors with alternating current flow is defined as a signal net. In contrast to conductors with direct current flow, conductors with alternating current flow do not directly cause EM problems. However, conductors with alternating current flow do use power and generate heat. Since EM is very sensitive to the temperature of the conductors, it is often necessary to limit the temperature increase of the conductors in IC devices that results from the heating due to alternating current flow. Therefore, the alternating current flow in a conductor does have an impact on EM because the heating due conductors with alternating current may increase the overall temperature of the IC device by heating up neighboring conductors with direct current flow.

As noted above, EM effects also become more prominent as IC feature size decreases. To counteract this effect, background art methods for controlling EM used wider conductor widths for an entire IC wiring network affected by EM. However, since EM problems become less severe as one moves away from a current source pin and toward each of the current sink pins of a wiring network, wider conductor widths are typically not required for the entire IC wiring network. Often, only a small segment of the IC wiring network needs the wider conductor width to eliminate EM problems for the entire IC wiring network. Therefore, these background art methods that use wider conductors throughout the IC wiring network often wastes valuable space on the IC device.

Other background art methods provide EM control by setting limits on the power dissipated in conductors with alternating current flow. In these background art methods adjacent conductors with direct current flow are only allowed to be heated by a maximum temperature difference .DELTA.T.sub.MAX in order to maintain the reliability of the IC device. In particular, to limit the heat generated as a result of the temperature difference .DELTA.T caused by alternating current flow in adjacent conductors, a maximum root-mean-square (RMS) current limit (I.sub.RMS) is set for all conductors with alternating current flow adjacent to a conductor with direct current flow. The maximum current limit is set by: (1) considering the minimum distance between conductors with alternating current flow and conductors with direct current flow; and (2) the maximum temperature difference .DELTA.T.sub.MAX that maintains the reliability of the IC device. However, using this type of worst-case “minimum distance-between-conductors” approach to determine space between conductors also wastes valuable space on the IC device.

Electromigration failures take time to develop, and are therefore very difficult to detect until it happens. Therefore, it is imperative to eliminate electromigration and self heating issues in order to maintain a reliable integrated circuit operation for many years. The system and method described in this invention automatically eliminates electromigration and self heating issues by reading an integrated circuit database file in GDSII format and produces electromigration and self heat correct layout block. The system is automatically adjusting metal lines, contacts and VIA'a, maintaining the process design rules correctness. In this way a significant amount of time is saved during the final reliability verification of the integrated circuit, achieving on-time tape outs and avoiding re-spins.

### SUMMARY OF THE INVENTION

In accordance with the present invention, the disadvantages and problems associated with eliminating electromigration and self heat violations of a mask layout block have been substantially reduced or eliminated. In a particular embodiment, a method for eliminating electromigration and self heat violations of a mask layout block includes automatic correction of electromigration and self heat rule violations within mask layout block if identified, maintaining the process design rules correctness.

In accordance with one embodiment of the present invention, an automated method for eliminating electromigration and self heat violations of a mask layout block includes analyzing a selected polygon(s) in a mask layout block in GDSII format or any industry standard layout editor's database and obtaining one or more electromigration and self heat rules associated with the polygon from a technology or external constraints file. The method provides a violation marker associated with the selected position for the polygon that graphically represents a space, width or length in the mask layout block where the selected polygon's position complies with the electromigration and self heat rules.

In accordance with another embodiment of the present invention, an automated method for eliminating electromigration and self heat violations of a mask layout block includes analyzing a selected polygon in a mask layout block and identifying a electromigration and self heat violation in the mask layout block if the selected position, with or length of the polygon is less than electromigration and self heat value permitted from a technology or external constraints file. If the electromigration and self heat violation is identified, the system automatically correcting the violation by moving, adjusting or modifying the problematic polygon. The system works throughout entire layout block hierarchy.

In accordance with a further embodiment of the present invention, a computer system for eliminating electromigration and self heat violations of a mask layout block includes a processing resource coupled to a computer readable memory. Processing instructions are encoded in the computer readable memory. When the processing instructions are executed by the processing resource, the instructions analyze a selected polygon in a mask layout block and identify an electromigration and self heat violation in the mask layout block if the selected position is less than an electromigration and self heat rule from a technology or external constraints file. If the electromigration and self heat violation is identified, the instructions automatically correcting it via adjusting, moving or modifying the analyzed polygon.

Important technical advantages of certain embodiments of the present invention include an electromigration-self heat Auto Correct (EMSH Auto Correct) tool that automatically corrects electromigration and self heat violations of a mask layout block while maintaining the process design rules correctness. A layout designer may execute an IC layout block with electromigration and self heat violations. The EMSH Auto Correct tool highlights a violation marker that may represent a width, space or length in the layout block and eliminates the electromigration and self heat violation according to technology or external constraints file. In addition the EMSH Auto Correct tool provides an information window with the current and fixed electromigration and self heat conditions related to the selected polygon. The correction action may change the selected polygon width, length or space according to electromigration and self heat rules taken from technology or external constraints file while maintaining the process design rule correctness. In case of contacts or vias individual or multiple selections, the system will automatically adjust the amount of contacts or vias according to electromigration and self heat rules taken from technology or external constraints file. The mask layout block, therefore, may be free of electromigration and self heat violations.

Another important technical advantage of certain embodiments of the present invention includes EMSH Auto Correct tool that significantly reduces the design time for an integrated circuit. In a typical integrated circuit design process, an electromigration and self heat check (EMSH Check) tool analyzes a mask layout file for electromigration and self heat violations and identifies any violations in an output file. A layout designer may use the output file to manually eliminate the identified electromigration and self heat violations. Then the same IC layout block needs to be re-checked for electromigration and self heat again and also other checks like DRC (Design Rule Check) and LVS (Layout vs. Schematics) to make sure that the connectivity and geometrical sizes are still correct according to technology file and schematics respectfully. These repeated cycles are time consuming and tedious procedures that can be eliminated using the presented invention. The time needed to complete the entire design process for the integrated circuit, therefore, may be substantially reduced since the steps of checking the layout with an EMSH tool and correcting the identified electromigration and self heat violations may be eliminated.

All, some, or none of these technical advantages may be present in various embodiments of the present invention. Other technical advantages will be readily apparent to one skilled in the art from the following figures, descriptions, and claims.

### BRIEF DESCRIPTION OF THE DRAWINGS

A more complete and thorough understanding of the present embodiments and advantages thereof may be acquired by referring to the following description taken in conjunction with the accompanying drawings, in which like reference numbers indicate like features, and wherein:

FIG. 1 illustrates seven Metals wires. These wires are connected through VIA1 (For Metal1 to Metal2 connection) and VIA2. (For Metal2 to Metal3 connection)

FIG. 2 illustrates seven Metals, each analyzed for electromigration and/or self heat conditions, defined by the process technology and/or external constraints file. All Metal2 lines WIDTH was found smaller then required for electromigration and self heat rules. Metal3 line LENGTH was found shorter then required by electromigration and self heat rules. The information violation markers represent an electromigration and self heat violations on the polygons that they are attached into.

Metal 2 wires have WIDTH violation shown by violation markers.

Metal 3 wire has LENGTH violation shown by violation markers.

FIG. 3 illustrates the Metal2 and Metal3 lines after the EMSH Auto Correct tool correction action. The Metal2 lines are WIDER and include more VIA1's. The Metal3 line is LONGER and includes more VIA2. When hovering above the INFORMATION marker, option windows will appear with the option to ACCEPT the correction or to CANCEL it. User may choose to accept or cancel some of the corrections only.

FIG. 4 Illustrates top level IC layout block that includes sub-cells. The EMSH Auto Correct tool checks the layout block fully hierarchically, marking all EM and self heat violations using violation marker. Upon the user's acceptance all these violations will be automatically fixed.

FIG. 5 illustrates a flow chart for one example of a method for automatic elimination of electromigration and/or self heat violations of a mask layout block in accordance with teachings of the present invention.

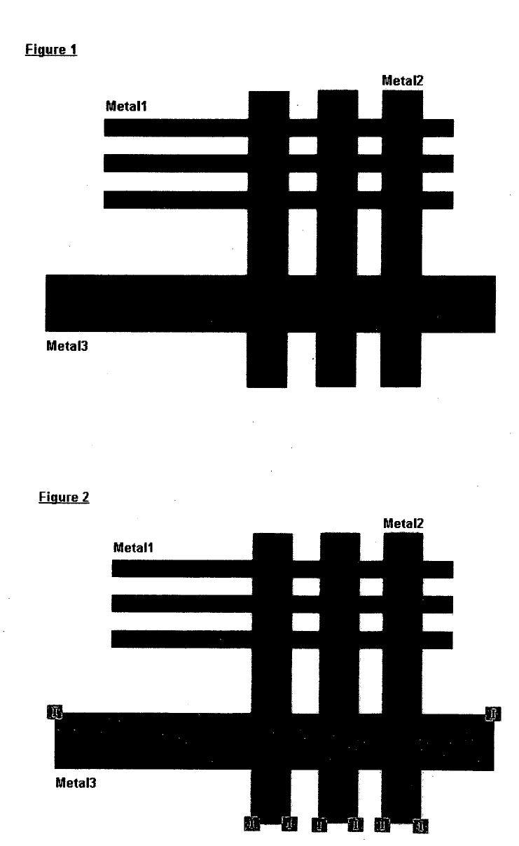

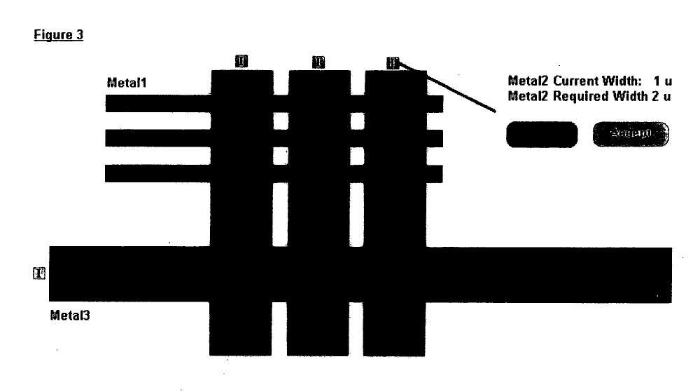

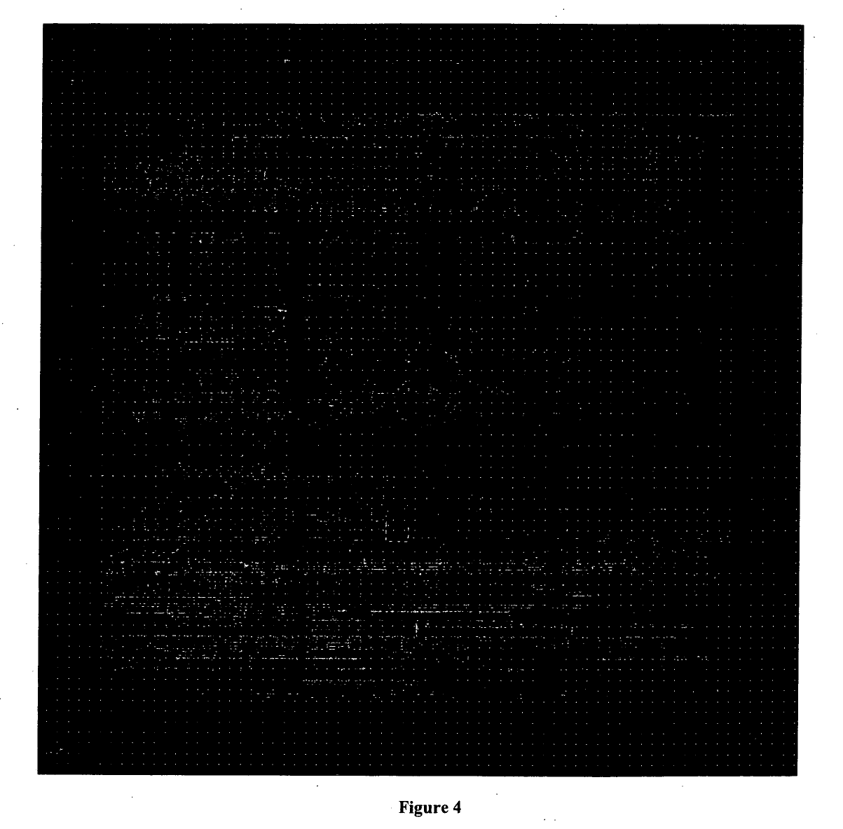

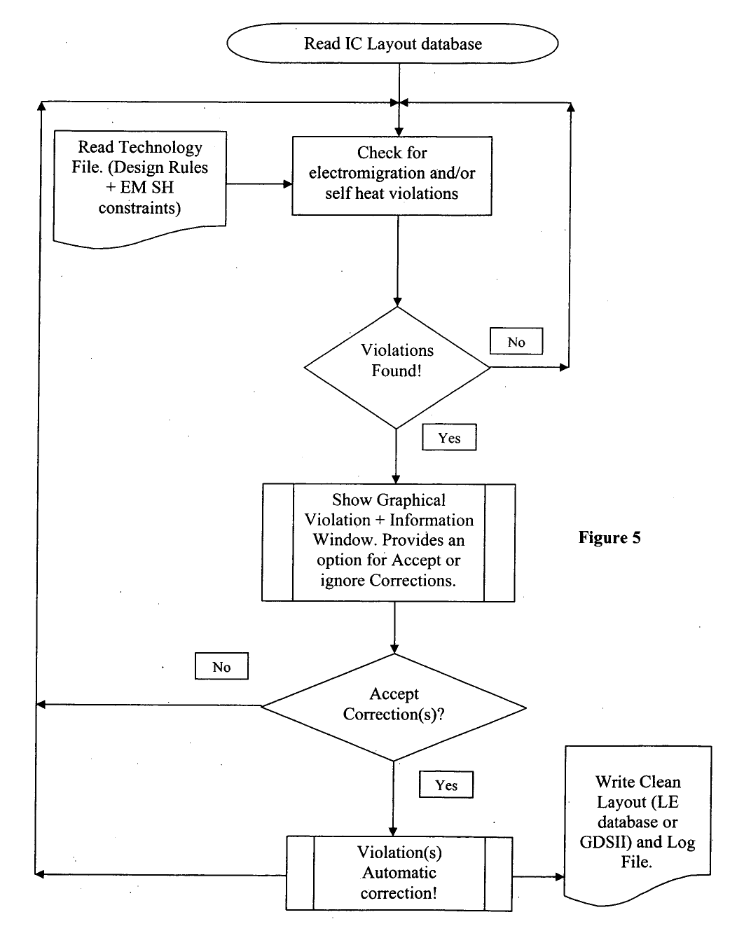

### DETAILED DESCRIPTION OF THE INVENTION

The processing instructions may include a commercially available layout editor interfaced with an electromigration-self-heat Auto correct (EMSH Auto Correct) tool or an independent IC layout block in GDSII format. The EMSH Auto Correct tool may provide the ability to analyze the width, length and placement of polygons in a mask layout block and determine if an electromigration and/or self heat violation was created. In addition the EMSH Auto Correct tool may provide the ability to analyze the number of contacts and VIA's, determine the amount needed in order to comply with electromigration and self heat rules. The EMSH Auto Correct tool may automatically correct all electromigration and/or self heat violation maintaining process design rules correctness.

After a layout designer creates a mask layout block it may contain electromigration and/or self heat violations. The EMSH Auto Correct tool reads the layout block information from GDSII format file or from industry standard layout editor's database system. In addition the EMSH Auto Correct tool reads a technology and/or external constraints file corresponding to a desired manufacturing process. The technology file may contain design rules for the desired manufacturing process that ensures an integrated circuit fabricated on a semiconductor wafer functions correctly. In addition the technology file may contain electromigration and self heat rules to ensure reliable integrated circuit operation for desired time period.

Furthermore, the tool has an option to read another constraints file which contains layout extraction information (resistance and capacitance values) per circuit net. Within the mask layout block, the electromigration and self heat rules may define the minimum or maximum allowable feature dimensions (e.g., metal and polysilicons wires width, spaces and length) for the desired manufacturing process. In addition the electromigration and self heat rules may define the correct number of contacts and VIA's in order to maintain accurate electrical current flow without causing metal lines failures. The EMSH Auto Correct tool then uses the electromigration and self heat rules to automatically fix electromigration and self heat violations of the mask layout block.

The EMSH Auto Correct tool uses the electromigration and self heat rules to graphically display the violations through a violation marker layer that is provided with industry standard layout editors.

The EMSH Auto Correct tool may graphically represent the violation marker in the mask layout block by highlighting the required width, length or space with an appropriate color and/or pattern. The violation marker color and/or pattern can be set in an initial tool setup. In addition the EMSH Auto Correct tool may show an Information Window with the current and fixed results. The Information Window also provides with the option to accept the correct new layout or ignore the correction results.

After the EMSH Auto Correct tool completed its automatic electromigration and self heat correction, user may have the option to accept the corrected layout or to ignore it and return to the original layout cell. The EMSH Auto Correct tool may guide the layout designer about electromigration and self heat violations within the mask layout block using violation marker. If the layout designer chooses to comply with the electromigration and/or self heat corrections, the EMSH Auto Correct tool automatically creates new layout cell that includes all corrections and maintains the process design rules correctness.

The EMSH Auto Correct operates in flat mode and hierarchical mode. When layout designer chooses to work in hierarchical mode, the EMSH Auto Correct tool will work throughout the entire hierarchy correcting all electromigration and self heat violations. In Flat Mode the EMSH Auto Correct tool will fix all electromigration and self heat violations in the current cell level only.

The EMSH Auto Correct tool is included an entire layout block Check mode. This mode is aimed to be activation with the completion of the entire layout block. Using this feature the entire block will be analyzed for electromigration and self heat violations. When analysis is complete all violations will be shown using violation marker. This mode operates in flat or fully hierarchical mode.

The processing instructions for automatic correction of electromigration and/or self heat violations in a mask layout file may be encoded in computer-usable media. Such computer-usable media may include, without limitation, storage media such as floppy disks, hard disks, CD-ROMS, DVDs, read-only memory, and random access memory; as well as communications media such wires, optical fibers, microwaves, radio waves, and other electromagnetic or optical carriers.

1. An automated method for eliminating electromigration and/or self heat violations of a mask layout block, comprising: reading integrated circuit layout database in GDSII format or industry standards layout editor's database and; analyzing a selected polygon in the mask layout block; obtaining one or more electromigration and/or self heat rule associated with the polygon from a technology and/or external constraints file; providing an information window with the current and required integrated circuit electromigration and/or self heat parameters; providing a violation marker associated with the selected position for the polygon, the violation marker operable to graphically represent a width, space, length or any other polygon's characteristic (Polygon's Metal type) in the mask layout block where the selected polygon complies with the electromigration and/or self heat rules: and automatically correcting an electromigration or self heat rule violation maintaining the process design rules correctness.

2. The method of claim 1, further comprising: analyzing the mask layout block for existence of electromigration and/or self heat violations which are determined by a technology file and/or external constraints ASCII file which contains net's capacitance, resistance parameters and other integrated circuit relate reliability factors.

3. The method of claim 1, further comprising: determined if a selected area, through a selection box, contains sufficient amount of CONTACT or VIA polygons in order to comply with electromigration and/or self heat rule, taken from a technology and/or external constraints file; and automatically modifying the amount of CONATCTS or VIA polygons according to electromigration and/or self heat rule until matching the minimum required according to technology and/or external constraints file rule.

4. The method of claim 1, further comprising: determining if the selected position for the polygon creates a feature dimension in the mask layout block (space, width or length) greater than at least one of the electromigration and/or self heat rules; and correcting the selected position until the feature dimension is approximately equal to the at least one electromigration and/or self heat rule.

5. The method of claim 1, further comprising the electromigration and/or self heat rules selected from a group consisting of a metals spacing, polysilicon spacing, contact spacing and all types of VIA spacing.

6. The method of claim 1, further comprising the electromigration and/or self heat rules selected from a group consisting of a metals length, polysilicon length, contact length and all types of VIA length.

7. The method of claim 1, further comprising the electromigration and/or self heat rules selected from a group consisting of a metals width, polysilicon width, contact width and all types of VIA width.

8. The method of claim 1, wherein the selected position for the polygon comprises a location for the polygon in the mask layout block.

9. The method of claim 1, wherein the selected position for the polygon comprises a location for edges of the polygon in the mask layout block.

10. The method of claim 1, wherein the mask layout block is hierarchical.

11. An automated method for eliminating electromigration and/or self heat violations of a mask layout block, comprising: reading integrated circuit database file in GDSII format and; analyzing a selected polygon in the mask layout block; providing a violation marker associated with the polygon; determining if the selected position, width or length of the selected polygon produces a electromigration and/or self heat violation in the mask layout block based on a electromigration or self heat rule taken from a technology and/or external constraints file; and automatically correct the electromigration or self heat violation if exists, maintaining the process design rule correctness.

12. The method of claim 11, further comprising automatically placing the polygon in an original position in the mask layout block if the electromigration and/or self heat violation exists.

13. The method of claim 11, further comprising automatically adjusting the selected position until the electromigration and/or self heat violation is eliminated.

14. The method of claim 11, further comprising automatically adjusting the width of the selected polygon until the electromigration and/or self heat violation is eliminated.

15. The method of claim 11, further comprising automatically adjusting the length of the selected polygon until the electromigration and/or self heat violation is eliminated.

16. The method of claim 11, further comprising automatically adjusting the amount of the selected contacts or VIAs until the electromigration and/or self heat violation is eliminated.

17. The method of claim 11, wherein the mask layout block is hierarchical.

18. The method of claim 11, further comprising: the mask layout block including at least one top-level cell and one or more instances of a subcell located in the top-level cell; and determining if the selected position produces an electromigration and/or self heat violation in one or more instances of a subcell in the mask layout block, the subcell located in a top-level cell; and simultaneously correcting the electromigration and/or self heat violation if exists, maintaining the process design rules correctness.

19. The method of claim 11, further comprising generating a mask layout file from the mask layout block that does not include the electromigration and/or self heat violation.

20. A computer system for eliminating electromigration and/or self heat violations of a mask layout block, comprising: a processing resource; a computer readable memory; and processing instructions encoded in the computer readable memory, the processing instructions, when executed by the processing resource, operable to perform operations comprising: reading GDSII layout block or industry standard layout editor's database and; analyzing a selected polygon in the mask layout block; providing a violation marker associated with the polygon; providing an information window with the current and required integrated circuit electromigration and/or self heat parameters; determining if the selected position, width or length of the selected polygon produces a electromigration and/or self heat violation in the mask layout block based on an electromigration and/or self heat rule taken from a technology and/or external constraints file; and automatically correcting the electromigration and/or self heat violation if exists, maintaining process design rules correctness.

21. The system of claim 20, further comprising the instructions operable to perform operations including automatically placing the polygon in an original position in the mask layout block if the electromigration and/or self heat violation exists.

22. The system of claim 20, further comprising the instructions operable to perform operations including automatically adjusting the selected position until the electromigration and/or self heat violation is eliminated.

23. The system of claim 22, further comprising the instructions operable to perform operations including automatically adjusting the width and/or length of the selected polygon until the electromigration and/or self heat violation is eliminated.

24. The system of claim 20, further comprising the instructions operable to perform operations including automatically adjusting partial part of the polygon's width and/or length until the electromigration and/or self heat violation is eliminated.

25. The system of claim 20, further comprising the instructions operable to perform operations including: determining if the selected position for the polygon creates an electromigration and/or self heat violation in the mask layout block according to electromigration and/or self heat rule taken from a technology and/or external constraints file; and modifying the selected polygon position, width or length until the electromigration and/or self heat is approximately equal to the associated technology file rule and/or complying with external constraints file rule according to priority.

26. Software for eliminating electromigration and/or self heat violations of a mask layout block, the software being embodied in computer-readable media and when executed operable to: read integrated circuit database file in GDSII format and; analyze a selected polygon in the mask layout block; providing a violation marker associated with the polygon; providing an information window with the current and required integrated circuit electromigration and/or self heat parameters; and determining if the selected position, width or length of the selected polygon produces an electromigration and/or self heat violation in the mask layout block based on an electromigration and/or self heat rule from a technology and/or external constraints file; and automatically correct the electromigration and/or self heat violation if exists, maintaining the process design rules correctness.

27. The software of claim 26, further operable to automatically place the polygon in an original position in the mask layout block if the electromigration and/or self heat violation exists.

28. The software of claim 26, further operable to automatically adjust the selected polygon's position and width and length until the electromigration and/or self heat violation is eliminated.

29. The software of claim 26, further operable to automatically adjust the selected polygon's position and partial width and length until the electromigration and/or self heat violation is eliminated.

30. The software of claim 26, further operable to automatically adjust selected VIA's position and/or amount until the electromigration and/or self heat violation is eliminated.

31. The software of claim 26, further operable to automatically adjust selected CONTACTS position and/or amount until the electromigration and/or self heat violation is eliminated.

32. The software of claim 26, wherein the mask layout block is hierarchical.
